(19) United States
(12) Patent Application Publication
(10) Pub. No.: US 2018/0374054 A1
(43) Pub. Date: Dec. 27, 2018

(54) Assessment Score Analytics

(71) Applicant: International Business Machines Corporation, Armonk, NY (US)

(72) Inventors: Shanthan CHAMALA, Malvern, PA (US); Saraswathi S. PERUMALLA, VISAKHAPATNAM (IN); Rachael J. SYDNES, WAYNE, PA (US); Manikya NUKALA, VISAKHAPATNAM (IN)

(21) Appl. No.: 15/634,647

(22) Filed: Jun. 27, 2017

(51) Int. Cl. G06Q 10/10; G06N 5/04; G09B 7/02; G06T 11/20

(52) U.S. Cl. CPC G06Q 10/1053; G06T 11/206; G09B 7/02; G06N 5/04

(57) ABSTRACT

A system optimizes an effectiveness of assessments. An assessment evaluating system receives a plurality of assessment results from a plurality of assessment result providers. The assessment evaluating system renders the plurality of assessment results as a graphical representation, and applies analytic techniques to the graphical representation to evaluate the assessments and/or the assessment results. The assessment evaluating system automatically provides recommendations to modify the assessments and/or configuration data associated with the assessments when the assessment evaluating system detects variances in the graphical representation. The assessment evaluating system transmits the recommendations to a user display. The assessment evaluating system continually receives additional assessment results in the plurality of assessment results, and automatically performs the steps of rendering, applying, providing recommendations, and transmitting. The assessment evaluating system receives notification that at least one assessment has been modified, and automatically performs the steps of rendering, applying, providing recommendations, and transmitting.

### BACKGROUND

Companies often receive hundreds, if not thousands, of job applications from applicants seeking employment. These companies often provide assessment tests to potential applicants to identify competencies, and match applicants to positions. The assessment tests must be configured to identify the applicants who are good matches for positions. Therefore, it would be helpful to optimize an effectiveness of the assessment tests to ensure that the assessment tests identify suitable candidates, and to quickly identify and rectify situations when the assessment tests don't accurately assess the candidates.

### SUMMARY

According to an embodiment of the present invention, in a method for optimizing an effectiveness of assessments, an assessment evaluating system receives, from a plurality of assessment result providers, a plurality of assessment results. The assessment evaluating system renders the plurality of assessment results as a graphical representation. The assessment evaluating system applies analytic techniques to the graphical representation to evaluate at least one of the assessments and the assessment results. The assessment evaluating system automatically provides recommendations to modify at least one of the assessments and configuration data associated with the assessments when the assessment evaluating system detects variances in the graphical representation. The assessment evaluating system transmits the recommendations to a user display. The assessment evaluating system continually receives additional assessment results in the plurality of assessment results from the plurality of assessment results providers, and automatically performs the steps of rendering, applying, providing recommendations, and transmitting in response to receiving the additional assessment results.

In an example embodiment, the assessment evaluating system receives notification that at least one assessment has been modified. The assessment evaluating system then automatically performs the steps of rendering, applying, providing recommendations, and transmitting in response to modification of at least one assessment.

In an example embodiment, when the assessment evaluating system renders the plurality of assessment results as the graphical representation, the assessment evaluating system generates a histogram from the plurality of assessment results as the graphical representation.

In an example embodiment, when the assessment evaluating system applies analytic techniques to the graphical representation to evaluate at least one of the assessments and the assessment results, the assessment evaluating system performs a comparison between the graphical representation and a normalized graphical representation to detect assessment variances by identifying graphical variances in the graphical representation. The assessment variances comprise at least one of the assessments and the assessment results.

In an example embodiment, when the assessment evaluating system applies analytic techniques to the graphical representation to evaluate at least one of the assessments and the assessment results, the assessment evaluating system identifies at least one pattern in the graphical representation to identify assessment variances. The assessment variances comprise at least one of the assessments and the assessment results.

In an example embodiment, when the assessment evaluating system applies analytic techniques to the graphical representation to evaluate at least one of the assessments and the assessment results, the assessment evaluating system normalizes the assessment results to market standards.

In an example embodiment, when the assessment evaluating system applies analytic techniques to the graphical representation to evaluate at least one of the assessments and the assessment results, the assessment evaluating system adjusts an evaluation based on a variance threshold associated with a recipient of the evaluation.

In an example embodiment, when the assessment evaluating system automatically provides, by the assessment evaluating system, recommendations to modify at least one of the assessments and configuration data associated with the assessments when the assessment evaluating system detects variances in the graphical representation, the assessment evaluating system employs at least one of historical trends and social trends to differentiate between assessment variances, and changing trends in skill sets associated with candidates producing the assessment results.

In an example embodiment, when the assessment evaluating system transmits the recommendations to the user display, the assessment evaluating system notifies a user when modification is required for at least one of the assessments and configuration data associated with the assessments.

### BRIEF DESCRIPTION OF THE DRAWINGS

FIG. 1 illustrates an embodiment of a system for optimizing an effectiveness of assessments, according to embodiments disclosed herein.

FIG. 2 illustrates an example high level system for optimizing an effectiveness of assessments, according to embodiments disclosed herein.

FIG. 3 illustrates an example scoring pattern skewed to the left, according to embodiments disclosed herein.

FIG. 4 illustrates an example scoring pattern skewed to the right, according to embodiments disclosed herein.

FIG. 5 illustrates an example scoring pattern with an incorrect configuration, according to embodiments disclosed herein.

FIG. 6 illustrates an example scoring pattern with a corrected configuration, according to embodiments disclosed herein.

FIG. 7 is a flowchart illustrating an embodiment of a method for optimizing an effectiveness of assessments, according to embodiments disclosed herein.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

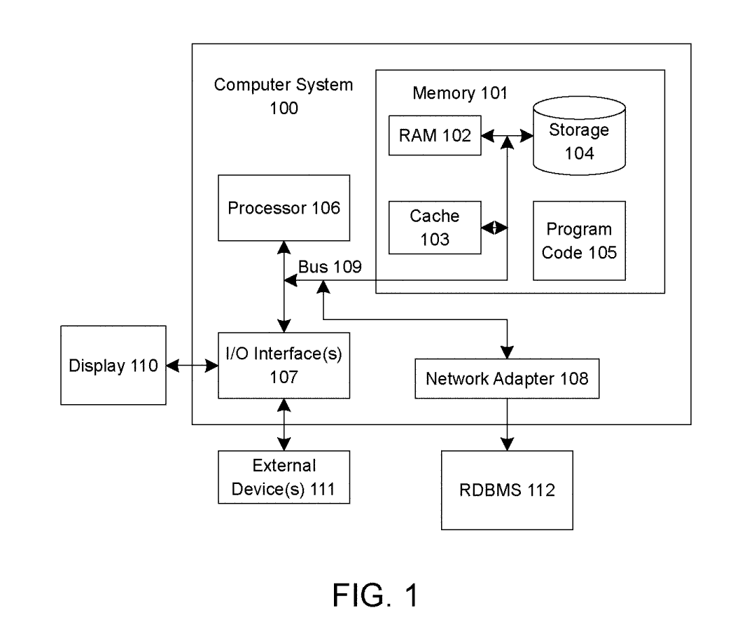

FIG. 1 illustrates a system for optimizing an effectiveness of assessments according to embodiments disclosed herein. The computer system 100 is operationally coupled to a processor or processing units 106, a memory 101, and a bus 109 that couples various system components, including the memory 101 to the processor 106. The bus 109 represents one or more of any of several types of bus structure, including a memory bus or memory controller, a peripheral bus, an accelerated graphics port, and a processor or local bus using any of a variety of bus architectures. The memory 101 may include computer readable media in the form of volatile memory, such as random access memory (RAM) 102 or cache memory 103, or non-volatile storage media 104. The memory 101 may include at least one program product having a set of at least one program code module 105 that are configured to carry out the functions of embodiments of the present invention when executed by the processor 106. The computer system 100 may also communicate with one or more external devices 111, such as a display 110, via I/O interfaces 107. The computer system 100 may communicate with one or more networks via network adapter 108. The computer system 100 may communicate with one or more databases 112 via network adapter 108.

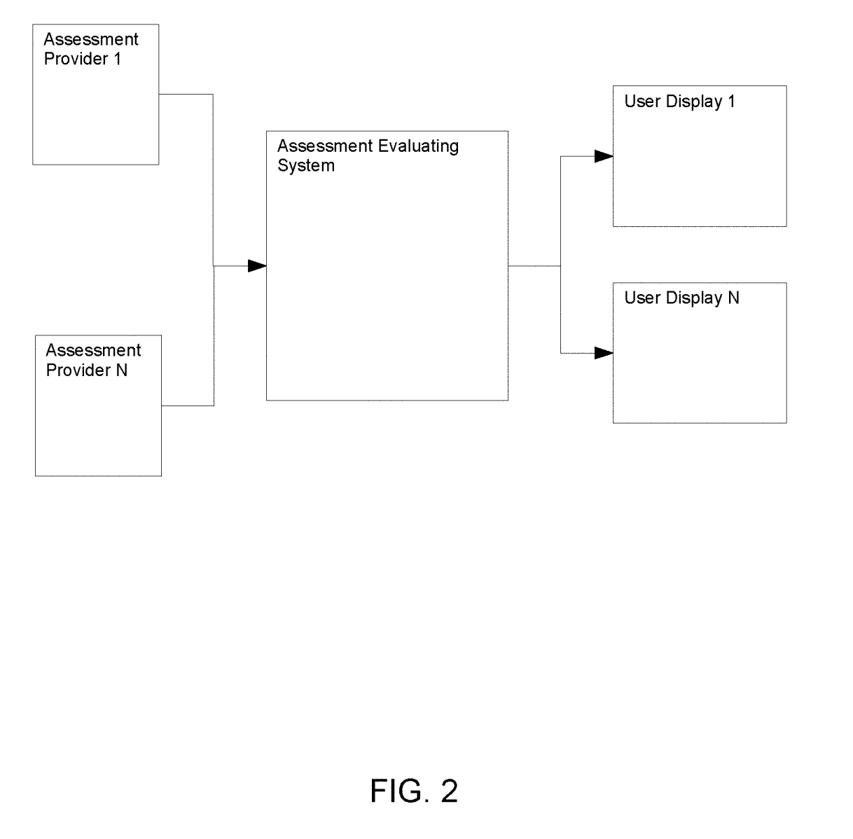

FIG. 2 illustrates an example high level system for optimizing an effectiveness of assessments, according to embodiments disclosed herein. In an example embodiment, many applicants take assessment tests to, for example, gauge the breadth and depth of their skill set. In an example embodiment, some test takers may be assessed for a particular position, while others may be assessed to identify which positions their skill set might be a good fit. Thus, there may be a wide range of skills represented by the test takers, both in breadth and depth of the skills and experience. The assessment evaluating system receives the assessments (often hundreds or thousands of them, sometimes from multiple providers), and renders them as a graphical representation. Hundreds and thousands of potential candidates may take assessments that produce the assessment results. The assessments may be presented to the potential candidates in an electronic format, and the assessment results are transmitted to and/or captured by the assessment providers. The assessment evaluating system receives assessment results from a plurality of assessment providers. The assessment evaluating system renders the plurality of assessment results as a graphical representation, and applies analytic techniques to the graphical representation to evaluate the assessments and/or the assessment results. The assessment evaluating system automatically provides recommendations to modify the assessments and/or configuration data associated with the assessments when the assessment evaluating system detects variances in the graphical representation. The assessment evaluating system then transmits the recommendations to one or more user displays.

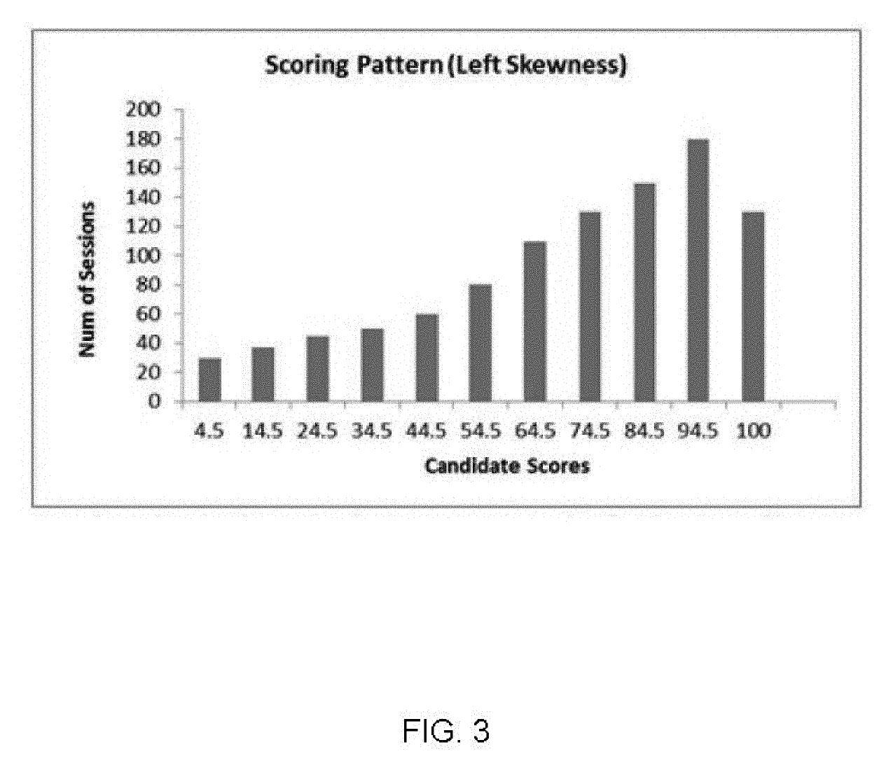

FIG. 3 illustrates an example scoring pattern skewed to the left. In this example embodiment, the graphical representation of the assessments reveals too many of the applicants have high scores. This indicates that the configuration of the assessments needs to be adjusted so that the graphical representation of the assessments reveals more of a normal distribution, such as a bell curve. Too many high scores may indicate that the assessments are too easy, are not configured correctly, and/or may be obsolete. As a result of an assessment that is not configured correctly, too many of the applicants are being advanced to the next step in the hiring process. This adds an extra burden to the hiring team who have to filter through the candidates to find those that are a good fit, and also wastes the time of the candidates who are not a good fit for the position. When the assessment evaluating system detects variances in the graphical representation of the assessments, the assessment evaluating system may provide recommendations to rectify the assessment results. For example, the recommendation may be to adjust the cut-off score to pass the assessment, review the assessment configuration, modify the assessment content, etc.

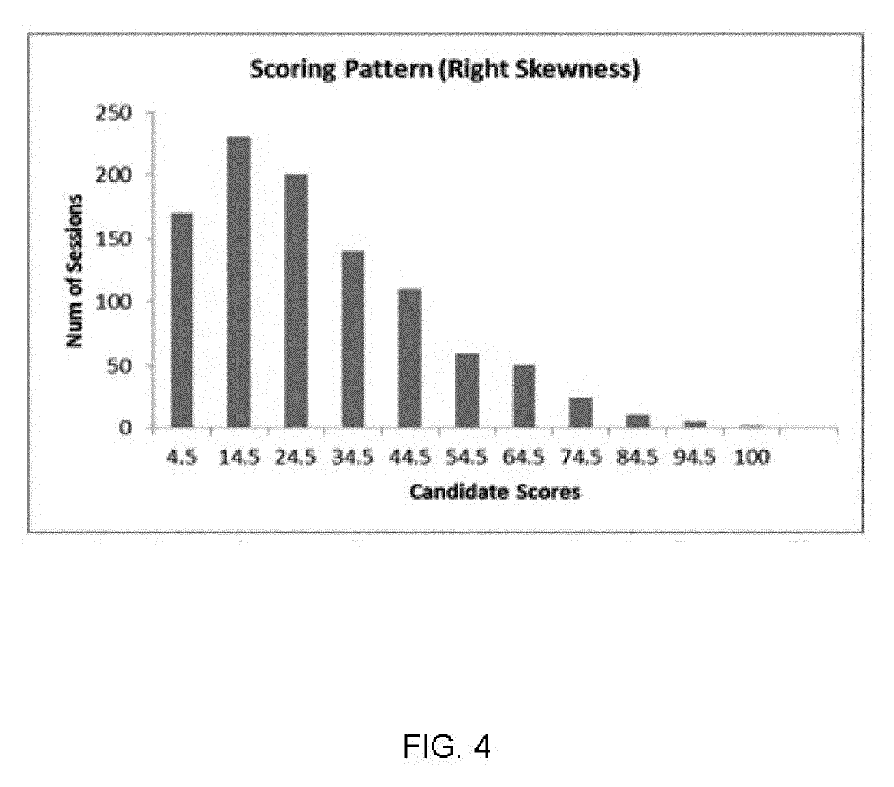

FIG. 4 illustrates an example scoring pattern skewed to the right. In this example embodiment, the graphical representation of the assessments reveals too few of the applicants are qualified to advance to the next step in the hiring process. This indicates that the configuration of the assessments needs to be adjusted so that the graphical representation of the assessments reveals more of a normal distribution, such as a bell curve. Too few passing scores may indicate that the assessments are too difficult, are not configured correctly, and/or may be obsolete. As a result of an assessment that is not configured correctly, too few of the applicants are being advanced to the next step in the hiring process. Skilled candidates may miss out on an opportunity for which they are qualified, while the hiring team may be left with a very diminished pool of qualified candidates. The hiring team may have to redouble their efforts to fill positions when there already exist qualified candidates who are interested in those positions, and who have completed the assessments. When the assessment evaluating system detects variances in the graphical representation of the assessments, the assessment evaluating system may provide recommendations to rectify the assessment results. For example, the recommendation may be to adjust the cut-off score to pass the assessment, review the assessment configuration, modify the assessment content, etc.

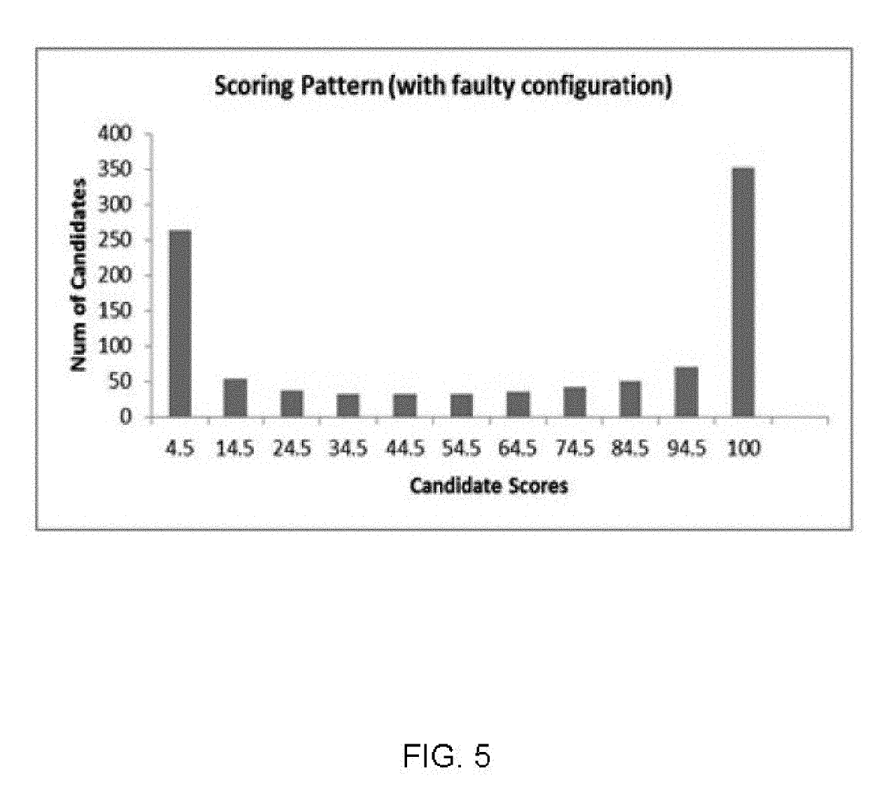

FIG. 5 illustrates an example scoring pattern with an incorrect configuration. In this example embodiments, the graphical representation displays scores that are either very high or very low. This may indicate that the configuration of the assessments is incorrect. In this example embodiment, the assessment evaluating system may identify this variance, and recommend that the configuration needs to be corrected.

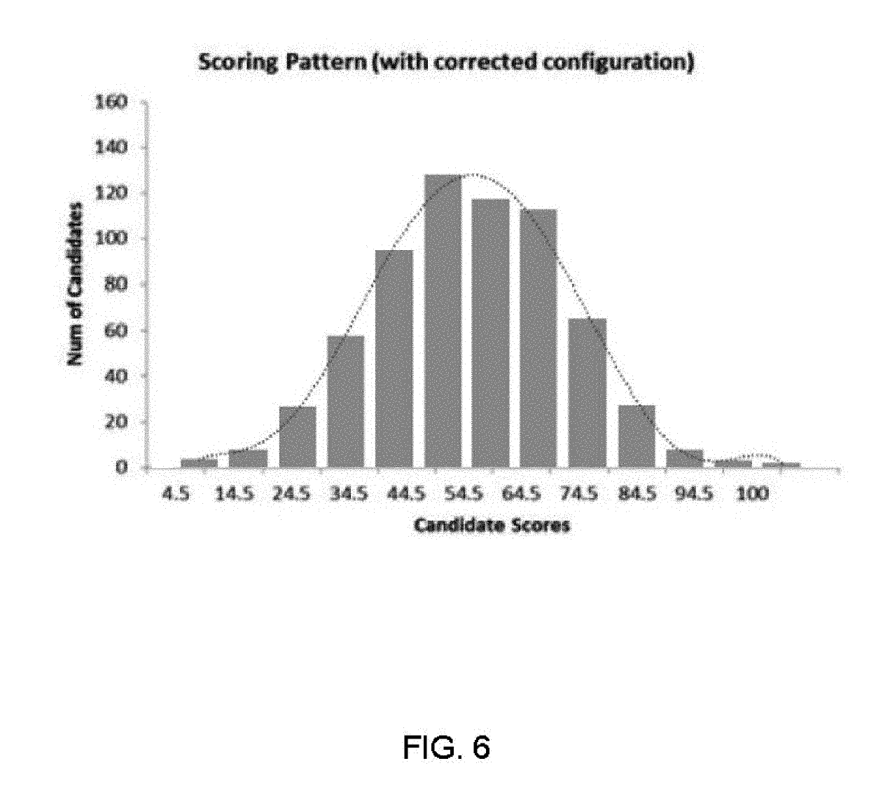

FIG. 6 illustrates an example scoring pattern with a corrected configuration, according to embodiments disclosed herein. In this example embodiment, the graphical representation of the assessments reveals a normal distribution of the candidate scores. For example, the assessment evaluating system may identify that the configuration needs to be adjusted, as illustrated in FIG. 5. The assessment evaluating system identifies variances in the graphical representation of the assessment results, and provides recommendations to a user to correct/adjust the configuration. Once the configuration is corrected, the assessment evaluating system automatically updates the graphical representation of the assessment results (and may also incorporate any new assessment results that the assessment evaluating system has received) and the resulting graphical representation displays a corrected graphical representation with a normal distribution of candidate scores, as illustrated in FIG. 6.

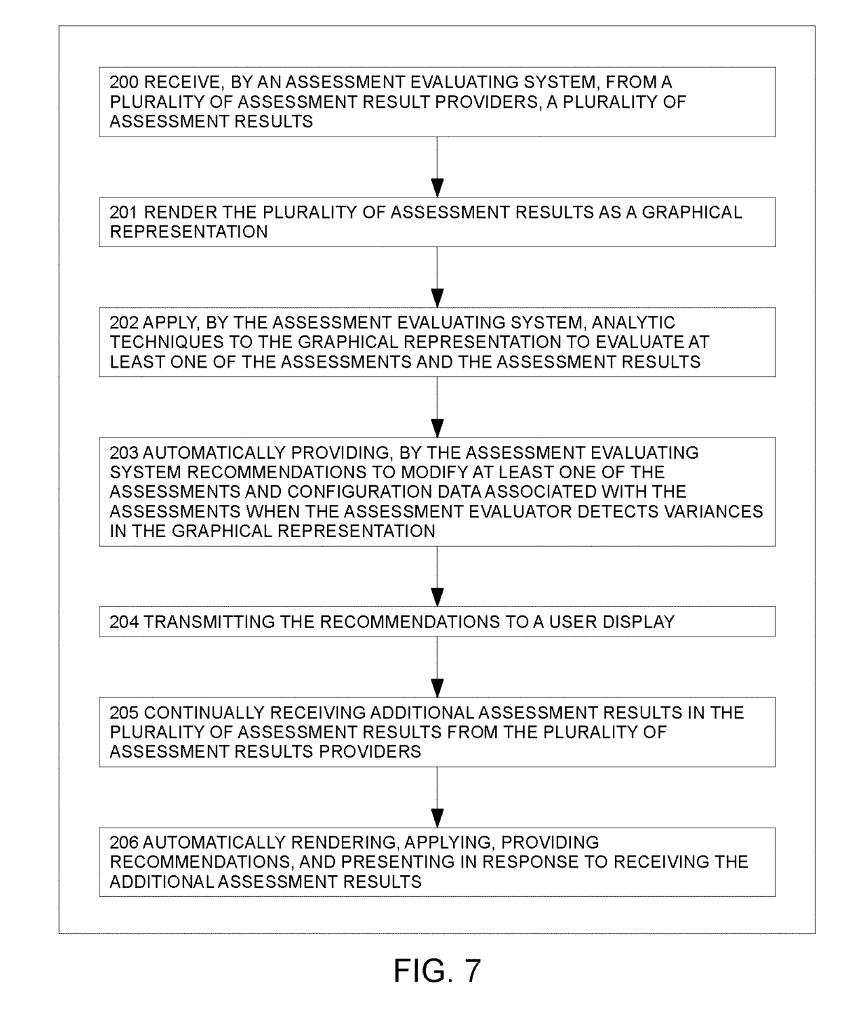

FIG. 7 is a flowchart illustrating an embodiment of a method for optimizing an effectiveness of assessments. At 200, the assessment evaluating system, executing on the processor 106, receives a plurality of assessment results from a plurality of assessment providers. Large companies may receive job applications from thousands of interested candidates. There are various ways to further narrow the applicant pool to determine which candidates to bring in for interviews. Companies may evaluate candidates by having those candidates complete assessment tests. Background assessments are used as part of the pre-hiring process, both for outside candidates, and employees who are interested in making an internal move within the company. The purpose of the assessments is to create a filtered down list of applicants. An important goal of the assessments is to efficiently filter out candidates who would not be a good fit for the position, while leaving a sufficient number of candidates in the pool of potential candidates who might be a good fit. It is critical that normal distributions of the assessments, and/or cut off scores are correctly identified to maximize the effectiveness of the assessments as a tool to identify qualified candidates. There may be multiple assessment providers that provide hundreds or thousands of completed assessments to the assessment evaluating system on an ongoing basis (i.e., daily, weekly, etc.). With so many candidates taking assessments for various positions, it may be impossible to efficiently determine when the assessments are identifying candidates who are not qualified, instead of qualified candidates. It may also be impossible to efficiently identify when qualified candidates are incorrectly being excluded. Further, it may be difficult to quickly identify when the assessments have become outdated, and/or when the configurations associated with the assessments need to be corrected/adjusted. By the time the hiring team makes this determination, good candidates may have been hired elsewhere, and the hiring team will have needlessly wasted their time on candidates who are not a good fit.

At 201, the assessment evaluating system renders the plurality of assessment results as a graphical representation to allow users to easily interpret the data. In an example embodiment, the graphical representations enable the user to recognize when an assessment and/or configuration of an assessment requires modification. In an example embodiment, some assessments score according to a normal distribution. The assessment compares a candidate's response to a larger population who also took that same assessment, and then identifies where the candidate falls within that larger population. For example, a candidate may have scored better than 90% of the other candidates who took the same assessment. This comparison is made by comparing the candidate to a normal distribution. If the normal distribution is off, then the comparison of the candidate will produce an incorrect evaluation of the candidate. In an example embodiment, the assessment evaluating system renders the received plurality of assessment results as a graphical representation as illustrated in FIGS. 3 through 6. In an example embodiment, the assessment evaluating system extracts the candidates scores from the assessments, both the overall score of the assessment, and at the trait/competency level of the assessment for any given timeframe. The assessment evaluating system then presents the assessment results in a graphical representation to allow easy and/or efficient interpretation of the data.

At 202, the assessment evaluating system applies analytic techniques to the graphical representation to evaluate the assessments and/or the assessment results. With so many candidates taking assessments, and the assessment evaluating system continually receiving a very large number of assessment results, there is a constant need for the assessments to be correct, for the configuration of the assessments to be correct, and for any anomalies in either to be quickly identified. As noted above, the assessment evaluating system may receive thousands of assessment results. With so much data, it may be difficult to see when the assessment results are trending away from a normal distribution. The analytic techniques allow a user, for example, a system administrator, to quickly identify when an assessment is not identifying appropriately skilled candidates (for example, screening out qualified candidates, moving unqualified candidates to the next level of screening, the assessments not configured correctly to identify the appropriate skill sets needed, etc.). The assessment evaluating system continually applies analytic techniques to the assessment results, for example, daily, weekly, monthly, etc. to identify trends in the assessments, the assessment results, and/or the configurations of the assessments. The assessment evaluating system may identify trends both in the overall assessment (i.e., the overall score of the assessments), and/or at the trait/competency level. In this example scenario, the user may quickly identify problems (with the assessments, the assessment results, and/or the configurations of the assessments), and rectify those problems. Without the ability to quickly identify and fix these problems, thousands of assessments will be performed without those assessments producing results that are accurate and useful to the hiring companies. Additionally, different companies may have different assessment requirements. For example, some companies may have more stringent requirements than other companies. Applying analytic techniques to the graphical representation of the assessment results enables companies to verify if the assessments are meeting their requirements levels, whether those requirements are more or less stringent than other companies. Additionally, companies can adjust their assessments based on the results of the analytic techniques to fine tune the assessment results based on the level of the companies' requirements. As companies change their requirements (for example, increasing the level of expertise required of suitable candidates), the companies can verify if their adjusted assessments are meeting the new level of requirements. In another example embodiment, if a company is unsuccessful in identifying suitable candidates, the assessment evaluating system may recommend modifications to the assessments and/or the configuration of the assessments based on data associated with other companies as determined by the assessment evaluating system. In other words, the assessment evaluating system may evaluate assessment results, and provide recommendations to multiple companies, and may be able to utilize the data of other companies to provide recommendations to a particular company.

At 203, the assessment evaluating system automatically provides recommendations to modify at least one of the assessments and configuration data associated with the assessments when the assessment evaluating system detects variances in the graphical representation. For example, the assessment evaluating system may detect that the graphical representation of the assessments results does not fall within a normal distribution, or the assessment results are trending away from a normal distribution. In an example embodiment, the assessment evaluating system may detect variances in the assessments, the configuration of the assessments, the assessment results, and/or the trait/competency levels within the assessments. In another example embodiment, the assessment evaluating system may detect variances in the skill sets of the candidates taking the assessments. The assessment evaluating system identifies these variances and provides recommendations to a user to, for example, modify the assessments, the configurations of the assessments, and/or configurations at the trait/competency level. In another example embodiment, the assessment evaluating system may make recommendations based on the goal of the user. For example, some users (i.e., hiring companies) may value technical skills over personality assessments for a particular position. The assessments may comprise the same test items, but, for a particular position for example, programming skills may be more important than teamwork skills. In this example scenario, the assessment evaluating system may provide recommendations based on the hiring goals identified by the user. By providing automated recommendations, the assessment evaluating system reduces any manual effort on the part of the user, and/or the cost of assessment maintenance. The automated recommendations also ensure assessment quality through rapid detection and notification of assessment and/or configuration abnormalities.

At 204, the assessment evaluating system transmits the recommendations to a user display. The assessment evaluating system may present the graphical representation of the assessment results in a dashboard display for the user, for example, as illustrated in FIGS. 3-6. The assessment evaluating system may also transmit recommendations to a user on the dashboard display. For example, the assessment evaluating system may identify when variances in the graphical representation of the assessment results are due to the assessments and/or the configuration of the assessments. The user may choose to view the graphical representation results presented as daily/weekly/monthly/etc. results. The user may also choose to view the trending behavior of the assessment results according to a daily/weekly/monthly/etc. timeline.

At 205, the assessment evaluating system continually receives additional assessment results in the plurality of assessment results from the plurality of assessment results providers. In an example embodiment, on a daily basis, thousands of candidates may be taking assessments. The assessment providers transmit the assessment results to the assessment evaluating system continually. In response, at 206, the assessment evaluating system automatically performs the steps of rendering, applying, providing recommendations, and transmitting in response to receiving the additional assessment results. The continual receiving and updating of the assessment results allow the user to identify trends in the assessment results and/or the candidates applying to take the assessments, and rectify any problems. The continual receiving and updating of the assessment results also allows the user to view and process enormous amounts of continually arriving data that could not be processed manually.

In an example embodiment, the assessment evaluating system receives notification that at least one assessment has been modified. The assessment may be modified and/or the configuration of the assessment may be modified. In response, the assessment evaluating system automatically performs the steps of rendering, applying, providing recommendations, and transmitting. In other words, the assessment evaluating system updates the graphical representation, applies the analytic techniques to the graphical, and provides recommendation to the user as new data comes in, whether that data are assessments results, changes to the assessments and/or changes to the configurations of the assessments. In an example embodiment, the assessment evaluating system runs as a background process that processes every assessment and every result of every assessment. Periodically (for example, hourly, weekly, etc.), the assessment evaluating system processes the assessment results and renders the assessment results as a graphical representation for example, as a histogram. A user, such as a system administrator, may view the assessment results on a dashboard display, and also view the daily, weekly, etc. trends. As each assessment is modified, the assessment evaluating system automatically renders the graphical representation, applies the analytic techniques, provides recommendations, and transmits the recommendation to a user display. In another example embodiment, the assessment evaluating system may detect that the assessments have been modified, and in response, may automatically adjust the normal distribution, and/or cut off scores to account for then newly modified assessments.

In an example embodiment, when the assessment evaluating system renders the plurality of assessment results as the graphical representation, the assessment evaluating system generates a histogram from the plurality of assessment results as the graphical representation. The histogram patterns are derived based on the scores generated by the assessments. In an example embodiment, the assessment evaluating system may render the plurality of assessment results in any number of different ways to assist the user in identifying when there are variances in the assessment results, and/or when changes are necessary to the assessments and/or the configurations of the assessments.

In an example embodiment, when the assessment evaluating system applies analytic techniques to the graphical representation to evaluate at least one of the assessments and the assessment results, the assessment evaluating system performs a comparison between the graphical representation and a normalized graphical representation to detect assessment variances by identifying graphical variances in the graphical representation. The assessment variances may be the assessments and/or the assessment results.

In an example embodiment, when the assessment evaluating system applies analytic techniques to the graphical representation to evaluate at least one of the assessments and the assessment results, the assessment evaluating system identifies at least one pattern in the graphical representation to identify assessment variances. The assessment variances may be the assessments and/or the assessment results. For example, a user, such as an Administrator and/or an Assessment Administrator, may configure an assessment such that a certain percentage of the candidates should receive a particular score. If the scores (i.e., the assessment results) are not falling within the expected range (for example, according to a normal distribution), the assessment evaluating system detects this anomaly, and notifies the user that the assessment results are not falling into the expected range. The assessment evaluating system may notify the user that the assessment results did not fall into the expected range, for example, on particular days on which the assessments were taken by candidates. The assessment evaluating system may notify the user by presenting this information on a dashboard display. The assessment evaluating system may also present this data in a graphical format on the dashboard, and/or may transmit the graphical format to the user (for example, email the graphical format to the user, and/or transmit a screen shot of the graphical format). This information empowers the user to quickly identify variances in the assessments and make changes to the assessments and/or configurations to the assessments. For example, if modifications are made to the assessment, the assessment evaluating system provides the user with information to quickly identify if those changes are producing the intended result. If the assessment modifications produce unintended and/or unwanted results, then the user can quickly identify this problem, and undo the assessment modifications to revert back to the earlier version of the assessments. Thus, the assessment evaluating system provides data and recommendations not only for the assessments and the assessment configurations, but also for modifications to the assessments and assessment configurations.

In an example embodiment, when the assessment evaluating system applies analytic techniques to the graphical representation to evaluate at least one of the assessments and the assessment results, the assessment evaluating system normalizes the assessment results to market standards. In an example embodiment, market standards may be a particular skill level for a particular skill that a candidate at the high end of an assessment measurement could be expected to possess. For example, a Java programmer in 2017 may be expected to score 80% of the questions correctly for a particular assessment test to be in the top 30% of the candidates who took that same assessment test in 2014 or 2015. In an example embodiment, the assessment evaluating system may identify that the assessment results are not aligned with the market standards and/or market trends, and may make recommendations to adjust the assessments and/or configurations of the assessments to align with the market standards. In another example embodiment, the assessment evaluating system may identify market standards based on the assessment results, and/or may identify market standards based on other independent research, for example, by interfacing with an online repository that provides data related to market standards.

In an example embodiment, when the assessment evaluating system applies analytic techniques to the graphical representation to evaluate at least one of the assessments and the assessment results, the assessment evaluating system adjusts an evaluation based on a variance or anomaly threshold associated with a recipient of the evaluation. In an example embodiment, a recipient of the evaluation, for example, the user, may specified how far off the normal distribution the assessment results may trend before the assessment evaluating system notifies the user, and provides a recommendation.

In an example embodiment, when the assessment evaluating system performs the steps of automatically providing, by the assessment evaluating system, recommendations to modify at least one of the assessments and configuration data associated with the assessments when the assessment evaluating system detects variances in the graphical representation, the assessment evaluating system employs at least one of historical trends and social trends to differentiate between assessment variances, and changing trends in skill sets associated with candidates producing the assessment results. In an example embodiment, the assessment evaluating system may evaluate data over multiple years (both for a particular company and/or multiple companies) to provide recommendations to the user. The assessment evaluating system may utilize this data to identify historical and/or social trends, and then make recommendations based on those trends.

In an example embodiment, when the assessment evaluating system transmits the recommendations to the user display, the assessment evaluating system notifies a user when modification is required for at least one of the assessments and configuration data associated with the assessments. For example, the assessment evaluating system may recommend that a user needs to adjust what is considered to be the norm, adjust assessment content, introduce more scoring items into an assessment, adjust the testing time to make the assessments easier or more difficult, adjust a weight associated with individual items associated with the assessments (for example, if a particular skill is crucial, then test items associated with those skills may be weighted more than other test items when calculating scores), etc.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of optimizing an effectiveness of assessments, the method comprising:
receiving, by an assessment evaluating system, from a plurality of assessment result providers, a plurality of assessment results;
rendering the plurality of assessment results as a graphical representation;
applying, by the assessment evaluating system, analytic techniques to the graphical representation to evaluate at least one of the assessments and the assessment results;
automatically providing, by the assessment evaluating system, recommendations to modify at least one of the assessments and configuration data associated with the assessments when the assessment evaluating system detects variances in the graphical representation; and
transmitting the recommendations to a user display.

2. The method of claim 1 further comprising:
continually receiving additional assessment results in the plurality of assessment results from the plurality of assessment results providers; and
automatically rendering, applying, providing recommendations, and transmitting in response to receiving the additional assessment results.

3. The method of claim 1 further comprising:
receiving notification that at least one assessment has been modified; and
automatically rendering, applying, providing recommendations, and transmitting in response to modification of the at least one assessment.

4. The method of claim 1 wherein rendering the plurality of assessment results as the graphical representation comprises:
generating a histogram from the plurality of assessment results as the graphical representation.

5. The method of claim 1 wherein applying, by the assessment evaluating system, analytic techniques to the graphical representation to evaluate the at least one of the assessments and the assessment results comprises:
performing a comparison between the graphical representation and a normalized graphical representation to detect assessment variances by identifying graphical variances in the graphical representation, wherein the assessment variances comprise the at least one of the assessments and the assessment results.

6. The method of claim 1 wherein applying, by the assessment evaluating system, analytic techniques to the graphical representation to evaluate the at least one of the assessments and the assessment results comprises:
identifying at least one pattern in the graphical representation to identify assessment variances, wherein the assessment variances comprise the at least one of the assessments and the assessment results.

7. The method of claim 1 wherein applying, by the assessment evaluating system, analytic techniques to the graphical representation to evaluate the at least one of the assessments and the assessment results comprises:
normalizing the assessment results to market standards.

8. The method of claim 1 wherein applying, by the assessment evaluating system, analytic techniques to the graphical representation to evaluate the at least one of the assessments and the assessment results comprises:
adjusting an evaluation based on a variance threshold associated with a recipient of the evaluation.

9. The method of claim 1 wherein automatically providing, by the assessment evaluating system, recommendations to modify the at least one of the assessments and configuration data associated with the assessments when the assessment evaluating system detects variances in the graphical representation comprises:
employing at least one of historical trends and social trends to differentiate between assessment variances, and changing trends in skill sets associated with candidates producing the assessment results.

10. The method of claim 1 wherein transmitting the recommendations to the user display comprises:
notifying a user when modification is required for the at least one of the assessments and configuration data associated with the assessments.

11. A computer program product for optimizing an effectiveness of assessments, the computer program product comprising:
a computer readable storage medium having computer readable program code embodied therewith, the program code executable by a computer processor to:
receive, by an assessment evaluating system, from a plurality of assessment result providers, a plurality of assessment results;
render the plurality of assessment results as a graphical representation;
apply, by the assessment evaluating system, analytic techniques to the graphical representation to evaluate at least one of the assessments and the assessment results;
automatically provide, by the assessment evaluating system, recommendations to modify at least one of the assessments and configuration data associated with the assessments when the assessment evaluating system detects variances in the graphical representation; and
transmit the recommendations to a user display.

12. The computer program product of claim 11 further configured to:
continually receive additional assessment results in the plurality of assessment results from the plurality of assessment results providers; and
automatically render, apply, provide recommendations, and present in response to receiving the additional assessment results.

13. The computer program product of claim 11 further configured to:
receive notification that at least one assessment has been modified; and
automatically render, apply, provide recommendations, and present in response to modification of the at least one assessment.

14. The computer program product of claim 11 wherein the computer readable program code configured to render the plurality of assessment results as the graphical representation is further configured to:
generate a histogram from the plurality of assessment results as the graphical representation.

15. The computer program product of claim 11 wherein the computer readable program code configured to apply, by the assessment evaluating system, analytic techniques to the graphical representation to evaluate the at least one of the assessments and the assessment results is further configured to:
identify at least one pattern in the graphical representation to identify assessment variances, wherein the assessment variances comprise the at least one of the assessments and the assessment results.

16. A system comprising:
a computing processor; and
a computer readable storage medium operationally coupled to the processor, the computer readable storage medium having computer readable program code embodied therewith to be executed by the computing processor, the computer readable program code configured to:
receive, by an assessment evaluating system, from a plurality of assessment result providers, a plurality of assessment results;
render the plurality of assessment results as a graphical representation;
apply, by the assessment evaluating system, analytic techniques to the graphical representation to evaluate at least one of the assessments and the assessment results;
automatically provide, by the assessment evaluating system, recommendations to modify at least one of the assessments and configuration data associated with the assessments when the assessment evaluating system detects variances in the graphical representation; and
transmit the recommendations to a user display.

17. The system of claim 16 further configured to:
continually receive additional assessment results in the plurality of assessment results from the plurality of assessment results providers; and
automatically render, apply, provide recommendations, and present in response to receiving the additional assessment results.

18. The system of claim 16 further configured to:
receive notification that at least one assessment has been modified; and
automatically render, apply, provide recommendations, and present in response to modification of the at least one assessment. pg,21

19. The system of claim 16 wherein the computer readable program code configured to render the plurality of assessment results as the graphical representation is further configured to:
generate a histogram from the plurality of assessment results as the graphical representation.

20. The system of claim 16 wherein the computer readable program code configured to transmit the recommendations to the user display is further configured to:
notify a user when modification is required for the at least one of the assessments and configuration data associated with the assessments.
